(19) United States
(12) Patent Application Publication
(10) Pub. No.: US 2015/0205272 A1
(43) Pub. Date: Jul. 23, 2015

(54) DROPLET ACTUATOR WITH IMPROVED WASTE DISPOSAL CAPABILITY

(71) Applicants: Uichong Brandon Yi, San Diego, CA (US); David Cohen, Chapel Hill, NC (US); Donovan E. Bort, San Diego, CA (US); Andrew White, Ames, IA (US)

(72) Inventors: Uichong Brandon Yi, San Diego, CA (US); David Cohen, Chapel Hill, NC (US); Donovan E. Bort, San Diego, CA (US); Andrew White, Ames, IA (US)

(73) Assignee: ADVANCED LIQUID LOGIC, INC., RESEARCH TRIANGLE PARK, NC (US)

(21) Appl. No.: 14/237,026

(22) PCT Filed: Aug. 3, 2012
(86) PCT No.: PCT/US12/49507

§ 371 Date: Jul. 21, 2014

Related U.S. Application Data
(60) Provisional application No. 61/515,662, filed on Aug. 5, 2011.

(51) Int. Cl. G05B 15/02; G01N 27/453

(52) U.S. Cl. CPC G05B 15/02; G01N 27/453

(57) ABSTRACT

Methods, devices and systems for transporting a droplet along a droplet operations gap of a droplet actuator into contact with absorbent material to dispose of the droplet from the gap or from a region of the gap.

### 2 RELATED APPLICATIONS

This patent application is related to and claims priority to U.S. Provisional Patent Application No. 61/515,662, filed on Aug. 5, 2011, entitled “Droplet Actuator with Improved Waste Disposal Capability,” the entire disclosure of which are incorporated herein by reference.

### 1 GOVERNMENT INTEREST

This invention was made with government support under Grant No. N109PC20104 awarded by Department of Homeland Security, and Grant No. HG004354. The United States Government has certain rights in the invention.

### 3 FIELD OF THE INVENTION

The invention relates generally to devices and methods for enhancing waste disposal capacity in a droplet actuator.

### 4 BACKGROUND

A droplet actuator typically includes one or more substrates configured to form a surface or gap for conducting droplet operations. The one or more substrates establish a droplet operations surface or gap for conducting droplet operations and may also include electrodes arranged to conduct the droplet operations. The droplet operations substrate or the gap between the substrates may be coated or filled with a filler fluid that is immiscible with the liquid that forms the droplets. The capacity for storing waste fluid in a droplet actuator may be limited. Therefore, there is a need for new approaches to storing waste fluid in a droplet actuator.

### 5 SUMMARY OF THE INVENTION

The invention provides a method, which involves transporting a droplet along a gap to an electrode in a droplet actuator; and absorbing the droplet by an absorbent material to dispose of the droplet from the gap. The absorbent material may be situated in the gap or may be exterior to the gap and coupled by a fluid path to the gap such that a droplet from the gap may flow from the gap, through the fluid path, into contact with the absorbent material. The absorbent material may in some cases be separated from the droplet by an oil layer, and the droplet, which may be an aqueous droplet, may be transported through the oil layer into contact with the absorbent material. The absorbent material may in some cases be separated from the droplet by an oil layer which is in contact with the absorbent material, and the droplet, which may be an aqueous droplet, may be transported through the oil layer into contact with the absorbent material. Contacting the droplet with the absorbent material causes absorption.

In some cases, the method involves capillaring the droplet from the gap to the absorbent material to cause absorption. In some cases, the method involves porting the droplet from the gap to the absorbent material to cause absorption. In some cases, the method involves transporting the droplet into contact with the absorbent material to cause absorption. In some cases, the transporting is electrowetting mediated, or dielectrophoresis mediated. In some cases, the method involves flowing the droplet into contact with the absorbent material to cause absorption.

The absorbent material may be provided in a chamber in a droplet actuator cartridge. For example, the absorbent material may be provided in an on-actuator reservoir, or in an off-actuator reservoir, or in a hybrid reservoir. The absorbent material may be provided in an off-cartridge reservoir.

The invention provides a system including a processor; memory; and code stored in the memory that when executed causes the processor at least to: transport a droplet along a gap between a top surface and a bottom surface of an electrowetting droplet actuator; activate an electrode in the electrowetting droplet actuator that positions the droplet proximate an absorbent material; and permit absorption of the droplet by the absorbent material to dispose of the droplet from the gap. In some cases, the code further causes the processor to cause contact between the droplet and the absorbent material. In some cases, the code further causes the processor to cause capillary action of the droplet to the absorbent material. In some cases, the code further causes the processor to flow the droplet from a top substrate of the droplet actuator to the absorbent material. In some cases, the code further causes the processor to flow the droplet from a bottom substrate of the droplet actuator to the absorbent material. In some cases, the code further causes the processor to transport the droplet into contact with the absorbent material. In some cases, the code further causes the processor to flow the droplet into contact with the absorbent material. In some cases, the code further causes the processor to flow the droplet to a reservoir storing the absorbent material.

The invention provides a computer readable medium storing processor executable instructions for performing a method, the method including: transporting a droplet along a gap between a top surface and a bottom surface of an electrowetting droplet actuator; activating an electrode in the electrowetting droplet actuator that positions the droplet proximate an absorbent material; and absorbing the droplet by the absorbent material to dispose of the droplet from the gap. In some cases, the computer readable medium includes instructions for contacting the droplet with the absorbent material to cause absorption. In some cases, the computer readable medium includes instructions for capillaring the droplet from the gap to the absorbent material to cause absorption. In some cases, the computer readable medium includes instructions for flowing the droplet into contact with the absorbent material to cause absorption. In some cases, the computer readable medium includes comprising instructions for transporting the droplet into contact with the absorbent material to cause absorption.

### 6 DEFINITIONS

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating or direct current. Any suitable voltage may be used. For example, an electrode may be activated using a voltage which is greater than about 150 V, or greater than about 200 V, or greater than about 250 V, or from about 275 V to about 375 V, or about 300 V. Where alternating current is used, any suitable frequency may be employed. For example, an electrode may be activated using alternating current having a frequency from about 1 Hz to about 100 Hz, or from about 10 Hz to about 60 Hz, or from about 20 Hz to about 40 Hz, or about 30 Hz.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a fluid path that permits a droplet including the beads to be brought into a droplet operations gap or into contact with a droplet operations surface. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead, a portion of a bead, or only one component of a bead. The remainder of the bead may include, among other things, polymeric material, coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication Nos. 20050260686, entitled “Multiplex flow assays preferably with magnetic particles as solid phase,” published on Nov. 24, 2005; 20030132538, entitled “Encapsulation of discrete quanta of fluorescent particles,” published on Jul. 17, 2003; 20050118574, entitled “Multiplexed Analysis of Clinical Specimens Apparatus and Method,” published on Jun. 2, 2005; 20050277197. Entitled “Microparticles with Multiple Fluorescent Signals and Methods of Using Same,” published on Dec. 15, 2005; 20060159962, entitled “Magnetic Microspheres for use in Fluorescence-based Applications,” published on Jul. 20, 2006; the entire disclosures of which are incorporated herein by reference for their teaching concerning beads and magnetically responsive materials and beads. Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference. Bead characteristics may be employed in the multiplexing aspects of the invention. Examples of beads having characteristics suitable for multiplexing, as well as methods of detecting and analyzing signals emitted from such beads, may be found in U.S. Patent Publication No. 20080305481, entitled “Systems and Methods for Multiplex Analysis of PCR in Real Time,” published on Dec. 11, 2008; U.S. Patent Publication No. 20080151240, “Methods and Systems for Dynamic Range Expansion,” published on Jun. 26, 2008; U.S. Patent Publication No. 20070207513, entitled “Methods, Products, and Kits for Identifying an Analyte in a Sample,” published on Sep. 6, 2007; U.S. Patent Publication No. 20070064990, entitled “Methods and Systems for Image Data Processing,” published on Mar. 22, 2007; U.S. Patent Publication No. 20060159962, entitled “Magnetic Microspheres for use in Fluorescence-based Applications,” published on Jul. 20, 2006; U.S. Patent Publication No. 20050277197, entitled “Microparticles with Multiple Fluorescent Signals and Methods of Using Same,” published on Dec. 15, 2005; and U.S. Patent Publication No. 20050118574, entitled “Multiplexed Analysis of Clinical Specimens Apparatus and Method,” published on Jun. 2, 2005.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap.

The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a fluid path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), and other fluorinated monomers for plasma-enhanced chemical vapor deposition (PECVD). In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass) and PARYLENE™ N (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; and polypropylene. Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, and other fluorinated monomers for plasma-enhanced chemical vapor deposition (PECVD). Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., International Patent Pub. No. WO/2008/101194, entitled “Capacitance Detection in a Droplet Actuator,” published on Aug. 21, 2008, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1×-, 2×-3×-droplets are usefully controlled operated using 1, 2, and 3 electrodes, respectively. If the droplet footprint is greater than the number of electrodes available for conducting a droplet operation at a given time, the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the gap of a droplet actuator is typically filled with a filler fluid. The filler fluid may, for example, be a low-viscosity oil, such as silicone oil or hexadecane filler fluid. The filler fluid may fill the entire gap of the droplet actuator or may coat one or more surfaces of the droplet actuator. Filler fluids may be conductive or non-conductive. Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or fluid path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Transporting into the magnetic field of a magnet,” “transporting towards a magnet,” and the like, as used herein to refer to droplets and/or magnetically responsive beads within droplets, is intended to refer to transporting into a region of a magnetic field capable of substantially attracting magnetically responsive beads in the droplet. Similarly, “transporting away from a magnet or magnetic field,” “transporting out of the magnetic field of a magnet,” and the like, as used herein to refer to droplets and/or magnetically responsive beads within droplets, is intended to refer to transporting away from a region of a magnetic field capable of substantially attracting magnetically responsive beads in the droplet, whether or not the droplet or magnetically responsive beads is completely removed from the magnetic field. It will be appreciated that in any of such cases described herein, the droplet may be transported towards or away from the desired region of the magnetic field, and/or the desired region of the magnetic field may be moved towards or away from the droplet. Reference to an electrode, a droplet, or magnetically responsive beads being “within” or “in” a magnetic field, or the like, is intended to describe a situation in which the electrode is situated in a manner which permits the electrode to transport a droplet into and/or away from a desired region of a magnetic field, or the droplet or magnetically responsive beads is/are situated in a desired region of the magnetic field, in each case where the magnetic field in the desired region is capable of substantially attracting any magnetically responsive beads in the droplet. Similarly, reference to an electrode, a droplet, or magnetically responsive beads being “outside of” or “away from” a magnetic field, and the like, is intended to describe a situation in which the electrode is situated in a manner which permits the electrode to transport a droplet away from a certain region of a magnetic field, or the droplet or magnetically responsive beads is/are situated away from a certain region of the magnetic field, in each case where the magnetic field in such region is not capable of substantially attracting any magnetically responsive beads in the droplet or in which any remaining attraction does not eliminate the effectiveness of droplet operations conducted in the region. In various aspects of the invention, a system, a droplet actuator, or another component of a system may include a magnet, such as one or more permanent magnets (e.g., a single cylindrical or bar magnet or an array of such magnets, such as a Halbach array) or an electromagnet or array of electromagnets, to form a magnetic field for interacting with magnetically responsive beads or other components on chip. Such interactions may, for example, include substantially immobilizing or restraining movement or flow of magnetically responsive beads during storage or in a droplet during a droplet operation or pulling magnetically responsive beads out of a droplet.

“Washing” with respect to washing a bead means reducing the amount and/or concentration of one or more substances in contact with the bead or exposed to the bead from a droplet in contact with the bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### 7 BRIEF DESCRIPTION OF THE DRAWINGS

FIG. 1 illustrates a cross-sectional view of a portion of an example of a droplet actuator that has absorbent material installed in the top substrate;

FIG. 2 illustrates a cross-sectional view of the droplet actuator of FIG. 1 that has absorbent material installed in the bottom substrate;

FIG. 3 illustrates a cross-sectional view of the droplet actuator of FIG. 1 that has absorbent material installed between the bottom and top substrates;

FIG. 4 illustrates a cross-sectional view of a portion of an example of a droplet actuator that has a roll of absorbent material installed in an off-actuator reservoir;

FIG. 5 illustrates a cross-sectional view of an example of a droplet actuator that has multiple particles of absorbent material installed in an off-actuator reservoir;

FIGS. 6A and 6B illustrate a top view and cross-sectional view, respectively, of a portion of an example of a droplet actuator and an example of absorbent material installed in a large-area off-actuator reservoir;

FIGS. 7A and 7B illustrate a top view and cross-sectional view, respectively, of the droplet actuator of FIGS. 6A and 6B and another example of absorbent material installed in a large-area off-actuator reservoir; and

FIG. 8 illustrates a functional block diagram of an example of a microfluidics system that includes a droplet actuator.

FIG. 9 illustrates a microfluidics system in which a sensor is used to determine whether the absorbent material is saturated.

### 8 DESCRIPTION

The invention provides a droplet actuators designed for maximizing waste fluid storage capacity. The droplet actuator includes a droplet operations gap in which droplet operations are conducted to perform various chemical or biochemical techniques. Droplet operations may be controlled by electrodes arranged to control droplets within the droplet operations gap. The droplet operations gap may include a region for storing waste droplets. Often, the region will have a gap height which is greater than the gap height of the droplet operations gap, such that it is energetically favorable for droplets at the boundary between the two gaps to situate themselves in the larger gap. Sometimes the waste disposal will be situated above or below the droplet operations gap, and will be accessible by a fluid path that couples the waste disposal reservoir with the droplet operations gap. In accordance with the invention, a droplet may be transported into contact with a fluid passage leading from the droplet operations gap and into the waste disposal reservoir. The size of the gap, the fluid passage, and the reservoir may be selected to cause the droplet to flow into the reservoir, e.g., by capillary action. The invention provides a method of disposing of a waste droplet by transporting the droplet in a droplet operations gap into contact with an absorbent material. The absorbent material may be installed in the top substrate of the droplet actuator. The absorbent material may be installed in the bottom substrate of the droplet actuator. The absorbent material may be installed between the bottom and top substrates of the droplet actuator. The absorbent material may be provided with passages or interstices that increase surface area exposed to liquid in order to increase the amount of liquid absorbed or to increase the speed of absorption.

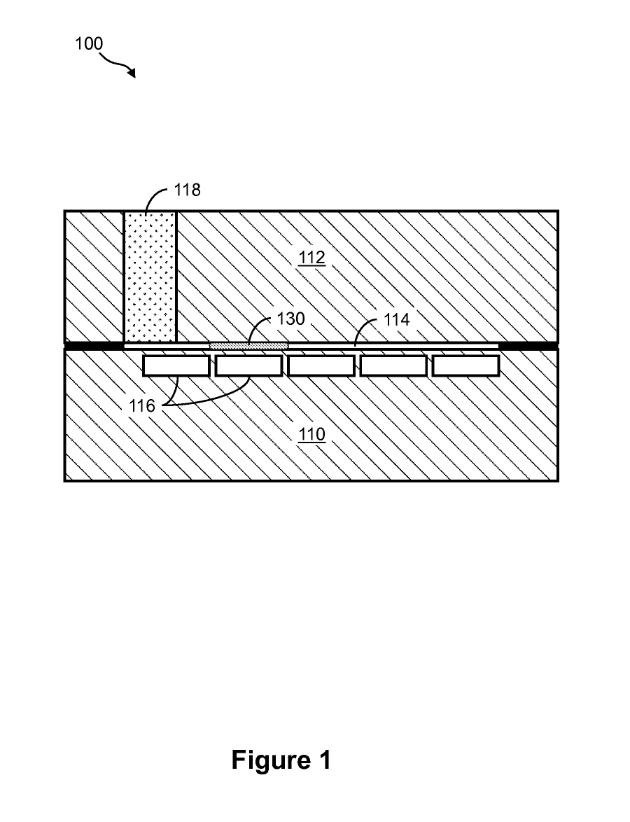

FIG. 1 illustrates a cross-sectional view of a portion of an example of a droplet actuator 100 that has absorbent material 118 installed in the top substrate 112. Droplet actuator 100 may include a bottom substrate 110 and a top substrate 112 that are separated by a droplet operations gap 114. Bottom substrate 110 may include droplet operations electrodes 116 (e.g., electrowetting electrodes) arranged to conduct droplet operations in droplet operations gap 114. Filler fluid (not shown) may be included in gap 114 surrounding droplet 130. The filler fluid may, for example, be a low-viscosity oil, such as silicone oil or hexadecane filler fluid. Droplet operations are conducted atop droplet operations electrodes 116 on a droplet operations surface. Bottom substrate 110 may, for example, be a printed circuit board (PCB). Top substrate 112 may, for example, be an injection molded plastic substrate.

Absorbent material 118 may be installed in top substrate 112 of droplet actuator 100. Absorbent material 118 in top substrate 112 is arranged such that waste fluid present in gap 114, such as a waste droplet 130, may be transported using droplet operations into contact with absorbent material 118 and absorbed by absorbent material 118.

Absorbent material 118 may be made from a material selected to absorb aqueous solutions (e.g., waste fluid). Ideally, absorbent material 118 absorbs aqueous droplets from within oil filler fluid without absorbing a substantial amount of the filler fluid. A substantial amount of the filler fluid in this context means an amount that would interfere with droplet operations or an amount that would prevent further absorption of droplets from within the filler fluid. Examples of suitable polymer include CHEM-POSITE Tri-Layer Laminate and CHEM-POSITE 11C-130 products. CHEM-POSITE Tri-Layer Laminate may be, for example, two layers of superabsorbent powder sandwiched between three layers of nonwoven material. CHEM-POSITE 11C-130 may be, for example, thermally and/or chemically bonded web. Additionally, absorbent material 118 may be formed of certain superabsorbent polymers, such as, but not limited to, LiquiBlock™ CSP, which is an acrylic copolymer using acrylic acid and acrylamide; and LiquiBlock™ 2G-110 and 2G-120, which is a polymer made with sodium salt with crosslinked polyacrylic acid. Examples of other polymers that may be suitable for absorbent material 118 may include, but are not limited to, polyvinyl alcohol (PVA), polyvinyl pyrrolidone (PVP), polyvinylidene fluoride (PVDF), hydrogel (also called aquagel), hydrophilic glass treated wool/mat, poly(lactic acid) or polylactide (PLA), agar (I.e., a mixture of agarose and agaropectin), and Dextran.

The invention provides a method of disposing of a droplet by transporting the droplet through a filler fluid and into contact with an absorbent material. The invention provides a method of disposing of a droplet by transporting the droplet using droplet operations through a filler fluid and into contact with an absorbent material. The invention provides a method of disposing of a droplet by transporting the droplet using droplet operations through a filler fluid and into an opening that fluidly couples the droplet operations gap with an absorbent material, such that the droplet flows through the opening into contact with the absorbent material. When the droplet contacts the absorbent material, it is partially or substantially absorbed by the absorbent material.

Referring again to FIG. 1, the method may include transporting via droplet operations a waste droplet, such as waste droplet 130 through a filler fluid along droplet operations electrodes 116 and into contact with absorbent material 118. Once in contact with absorbent material 118, waste droplet 130 is absorbed by absorbent material 118. Multiple waste droplets may be transported into contact with and absorbed by absorbent material 118. In this manner, absorbent material 118 provides improved waste fluid storage capacity that is outside of the droplet operations gap of the droplet actuator.

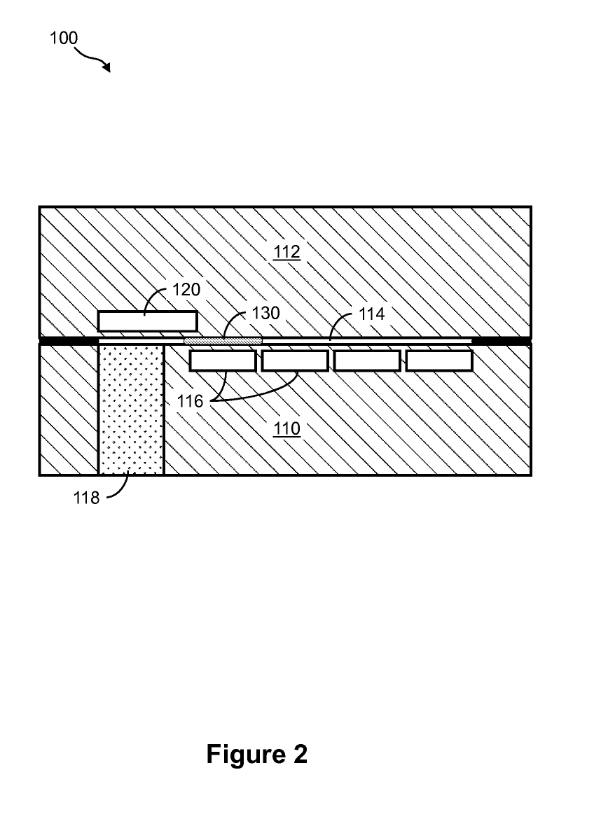

FIG. 2 illustrates a cross-sectional view of another example of droplet actuator 100. In this example, droplet actuator 100 has absorbent material 118 installed in the bottom substrate 110 thereof. The position of absorbent material 118 in bottom substrate 110 is such that waste fluid present in gap 114, such as waste droplet 130, may be transported using droplet operations into contact with absorbent material 118. For example, electrodes 120 may be used to transport waste droplet 130 by electrowetting into contact with absorbent material 118. Electrode 120 is situated across the gap from absorbent material 118 and may be used to transport droplet 130 into contact with absorbent material 118.

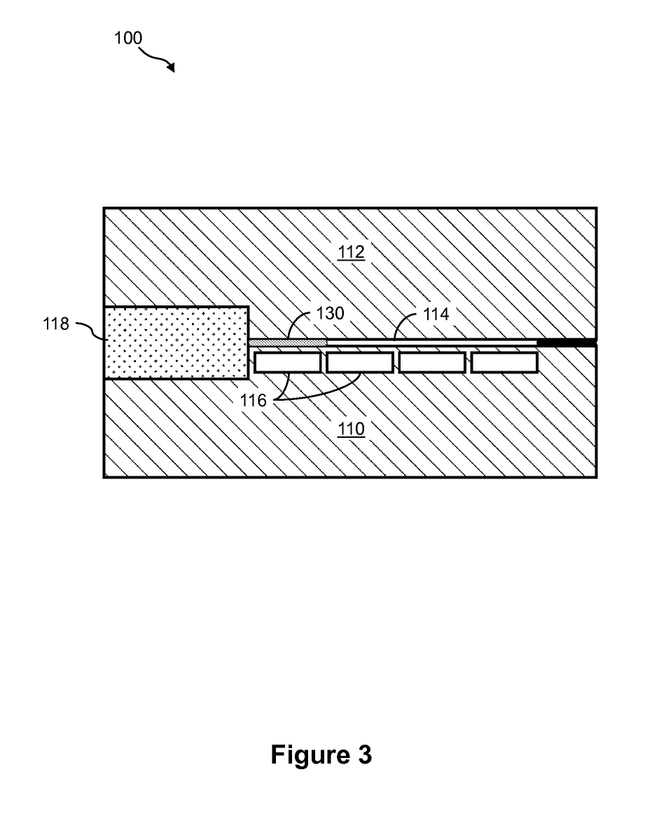

FIG. 3 illustrates a cross-sectional view of yet another example of droplet actuator 100. In this example, droplet actuator 100 has a certain amount of absorbent material 118 installed between the bottom substrate 110 and top substrate 112 thereof. The position of absorbent material 118 between bottom substrate 110 and top substrate 112 is such that waste fluid present in gap 114, such as waste droplet 130, may come into contact with absorbent material 118. For example, droplet operations may be used to transport waste droplet 130 into contact with absorbent material 118.

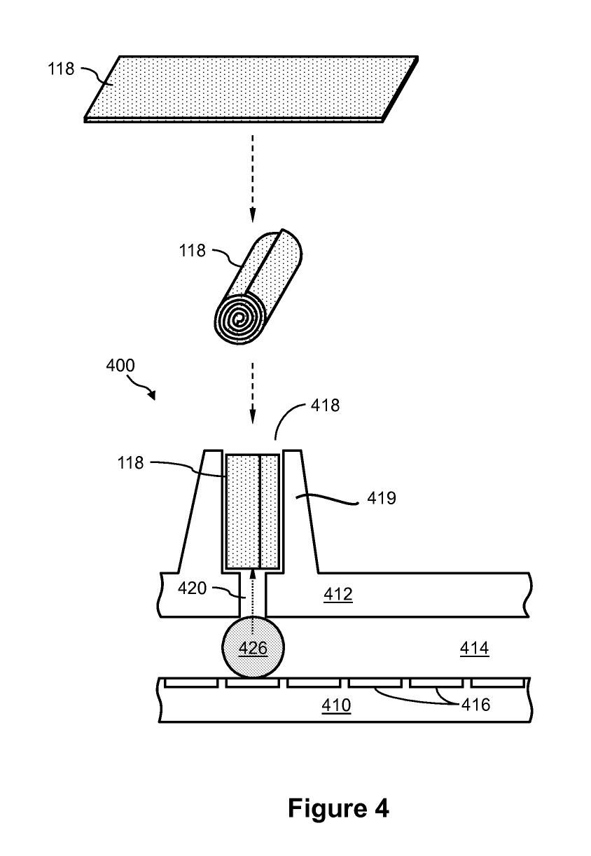

FIG. 4 illustrates a cross-sectional view of a portion of an example of a droplet actuator 400 that has a roll of absorbent material 118 installed in an off-actuator reservoir. Droplet actuator 400 may include a bottom substrate 410 and a top substrate 412 that are separated by a gap 414. Bottom substrate 410 may include a line, path, or array of droplet operations electrodes 416 (e.g., electrowetting electrodes). Filler fluid (not shown) is in gap 414. Droplet operations are conducted atop droplet operations electrodes 416 on a droplet operations surface. Bottom substrate 410 may, for example, be a PCB. Top substrate 412 may, for example, be an injection molded plastic substrate.

Additionally, an off-actuator reservoir 418 bounded by one or more reservoir walls 419 is integrated into top substrate 412. A port 420 provides a fluid path between off-actuator reservoir 418 and gap 414. Port 420 fluidly couples droplet operations gap 414 with reservoir 418. Liquid may flow through port 420 into and/or from any portion of gap 414. In one example, off-actuator reservoir 418 is used as a waste reservoir for storing waste fluid. For example, FIG. 4 shows a waste droplet 426 that is ready to be moved into off-actuator reservoir 418. Droplet 426 will flow through opening 420 by capillary action.

A thin sheet of absorbent material 118 may be rolled into a cylinder-shaped piece of absorbent material 118, as shown in FIG. 4. The roll of absorbent material 118 may then be installed end-wise in off-actuator reservoir 418 of droplet actuator 400. In this example, the rolled absorbent material 118 provides multiple layers of material and, therefore, provides increased surface area as compared with a solid piece of material of about the same volume. Once transported into off-actuator reservoir 418, waste liquid is exposed to the surface area of the multiple layers of absorbent material 118 and absorbed.

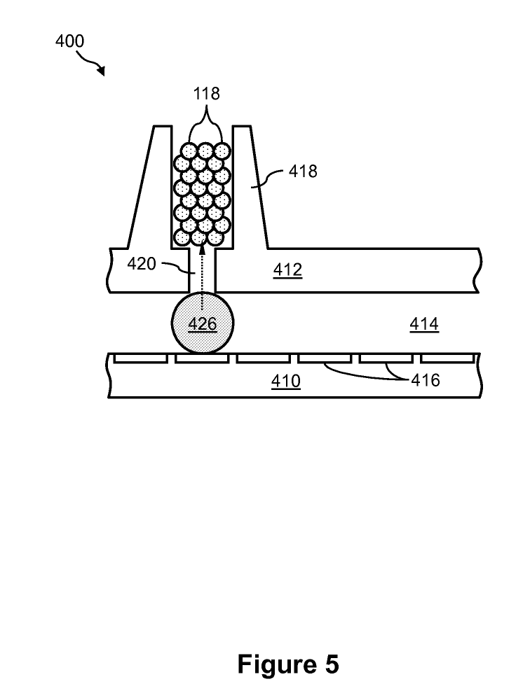

FIG. 5 illustrates a cross-sectional view of droplet actuator 400 of FIG. 4 with particles of absorbent material 118 provided in off-actuator reservoir 418. This approach increases the surface area exposed to droplet 426. In one example, the particles of absorbent material 118 are sphere-shaped. However, any shape or shapes may be used to provide particles of absorbent material 118 that will form interstices through which droplet 426 may flow. Again, once drawn into off-actuator reservoir 418, waste liquid is drawn into the body of particles by capillary action where it can be absorbed by the particles.

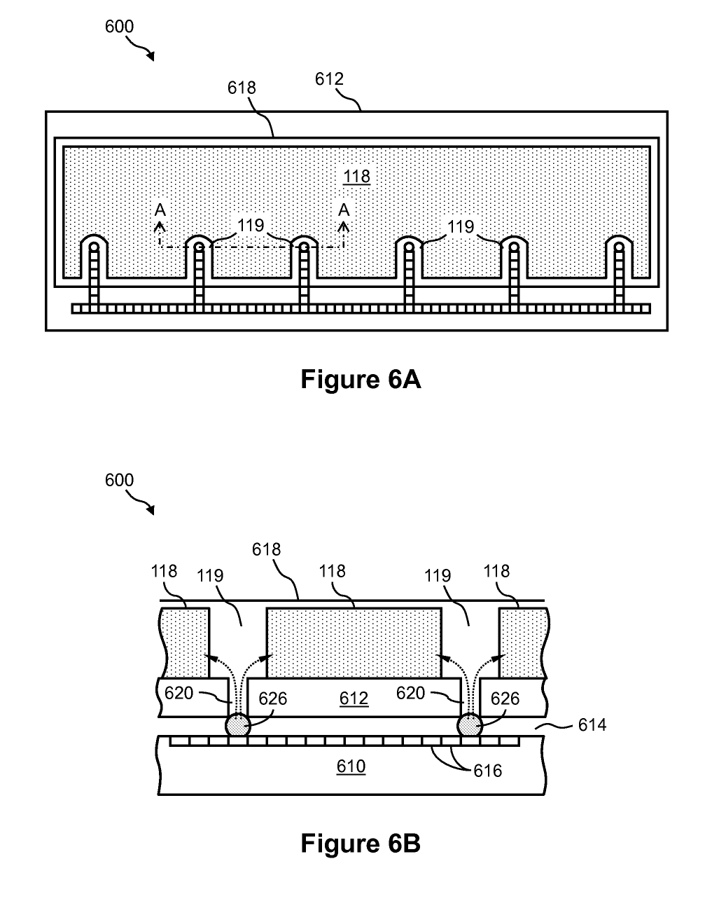

FIG. 6A illustrates a top view of a portion of a droplet actuator 600 and an example of absorbent material 118 installed in a large-area off-actuator reservoir. FIG. 6B illustrates a cross-sectional view of droplet actuator 600 taken along line AA of FIG. 6A. Droplet actuator 600 may include a bottom substrate 610 and a top substrate 612 that are separated by a gap 614. Bottom substrate 610 may include a line, path, or array of droplet operations electrodes 616 (e.g., electrowetting electrodes). Filler fluid (not shown) is in gap 614. Droplet operations are conducted atop droplet operations electrodes 616 on a droplet operations surface. Bottom substrate 610 may, for example, be a PCB. Top substrate 612 may, for example, be an injection molded plastic substrate. Additionally, a large-area off-actuator reservoir 618 is integrated into top substrate 612. Multiple ports 620 provide fluid paths between large-area off-actuator reservoir 618 and gap 614. The locations of the multiple ports 620 substantially correspond to the locations of lanes of droplet operations electrodes 616, as shown, such that droplets can be transported to the ports using droplet operations mediated by the electrodes.

In one example, large-area off-actuator reservoir 618 is used as a large volume waste reservoir for storing waste fluid. A continuous layer or block of absorbent material 118 is installed in large-area off-actuator reservoir 618 of droplet actuator 600. In this example, certain clearance regions 119 are present in the block absorbent material 118. Ports 620 provided fluid passage from droplet operations gap 614 into clearance regions 119. Again, waste liquid, such as waste droplets 626, is transported into openings 620, through which the droplets flow by capillary action into clearance regions 119, where they contact absorbent material 118 and are absorbed.

In one example, the block of absorbent material 118 may be formed separately from droplet actuator 600 and then installed therein. In another example, the block absorbent material 118 may be molded directly into large-area off-actuator reservoir 618 during the manufacturing of top substrate 612. That is, large-area off-actuator reservoir 618 of top substrate 612 may be filled with absorbent material 118. Then, the absorbent material 118 is cured, prior to assembly to bottom substrate 610.

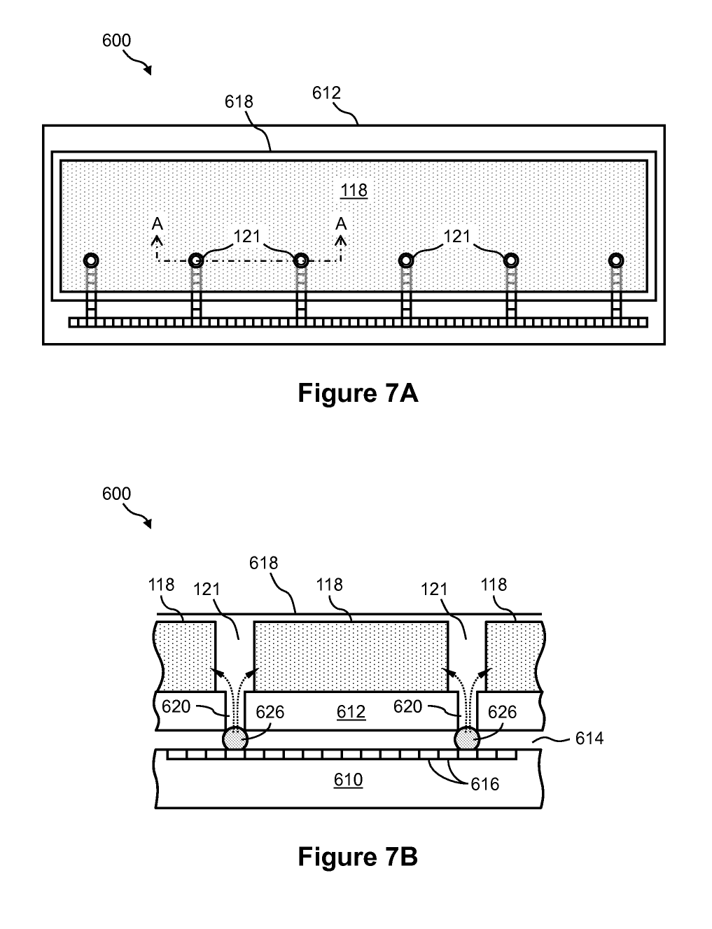

FIG. 7A illustrates a top view of droplet actuator 600 of FIGS. 6A and 6B and another example of absorbent material installed in large-area off-actuator reservoir 618. FIG. 7B illustrates a cross-sectional view of droplet actuator 600 taken along line AA of FIG. 7A. This example is substantially the same as described in FIGS. 6A and 6B, except that clearance regions 121 are cylindrical openings in absorbent material 118 in register with openings 620. The functioning is substantially the same as described with respect to the clearance regions 119 in FIGS. 6A and 6B.

### 8.1 Systems

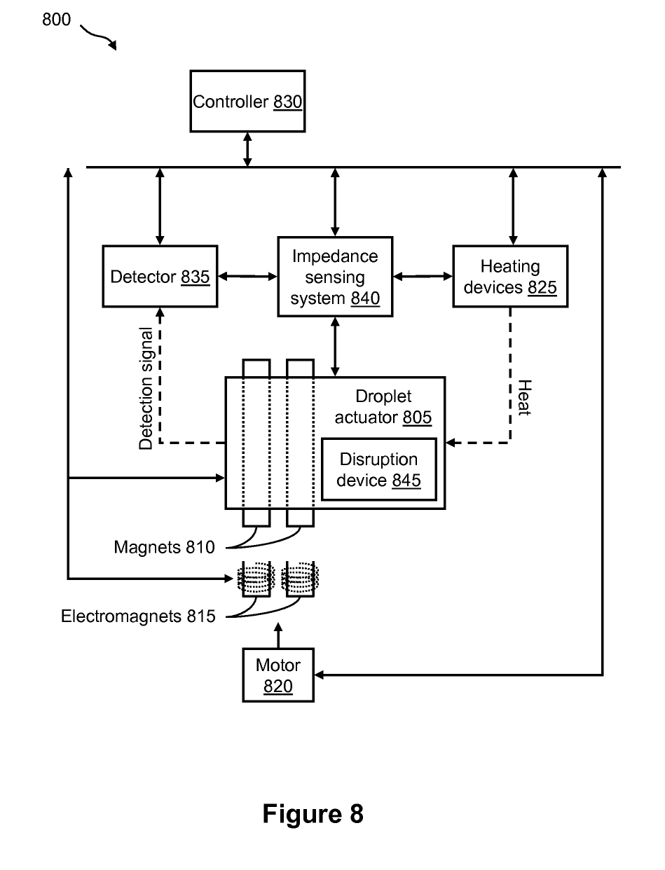

FIG. 8 illustrates a functional block diagram of an example of a microfluidics system 800 that includes a droplet actuator 805. Digital microfluidic technology conducts droplet operations on discrete droplets in a droplet actuator, such as droplet actuator 805, by electrical control of their surface tension (electrowetting). The droplets may be sandwiched between two substrates of droplet actuator 805, a bottom substrate and a top substrate separated by a gap. The bottom substrate may, for example, be a printed circuit board (PCB) with an arrangement of electrically addressable electrodes. The top substrate may, for example, be an injection molded plastic substrate that includes a reference electrode plane made, for example, from conductive ink or indium tin oxide (ITO). The bottom substrate and the top substrate may be coated with a hydrophobic material. The space around the droplets (i.e., the gap between bottom and top substrates) may be filled with an immiscible inert fluid, such as silicone oil, to prevent evaporation of the droplets and to facilitate their transport within the device. Other droplet operations may be effected by varying the patterns of voltage activation; examples include merging, splitting, mixing, and dispensing of droplets.

Droplet actuator 805 may be designed to fit onto an instrument deck (not shown) of microfluidics system 800. The instrument deck may hold droplet actuator 805 and house other droplet actuator features, such as, but not limited to, one or more magnets and one or more heating devices. For example, the instrument deck may house one or more magnets 810, which may be permanent magnets. Optionally, the instrument deck may house one or more electromagnets 815. Magnets 810 and/or electromagnets 815 are positioned in relation to droplet actuator 805 for immobilization of magnetically responsive beads. Optionally, the positions of magnets 810 and/or electromagnets 815 may be controlled by a motor 820. Additionally, the instrument deck may house one or more heating devices 825 for controlling the temperature within, for example, certain reaction and/or washing zones of droplet actuator 805. In one example, heating devices 825 may be heater bars that are positioned in relation to droplet actuator 805 for providing thermal control thereof.

A controller 830 of microfluidics system 800 is electrically coupled to various hardware components of the invention, such as droplet actuator 805, electromagnets 815, motor 820, and heating devices 825, as well as to a detector 835, an impedance sensing system 840, and any other input and/or output devices (not shown). Controller 830 controls the overall operation of microfluidics system 800. Controller 830 may, for example, be a general purpose computer, special purpose computer, personal computer, or other programmable data processing apparatus. Controller 830 serves to provide processing capabilities, such as storing, interpreting, and/or executing software instructions, as well as controlling the overall operation of the system. Controller 830 may be configured and programmed to control data and/or power aspects of these devices. For example, in one aspect, with respect to droplet actuator 805, controller 830 controls droplet manipulation by activating/deactivating electrodes.

In one example, detector 835 may be an imaging system that is positioned in relation to droplet actuator 805. In one example, the imaging system may include one or more light-emitting diodes (LEDs) (i.e., an illumination source) and a digital image capture device, such as a charge-coupled device (CCD) camera.

Impedance sensing system 840 may be any circuitry for detecting impedance at a specific electrode of droplet actuator 805. In one example, impedance sensing system 840 may be an impedance spectrometer. Impedance sensing system 840 may be used to monitor the capacitive loading of any electrode, such as any droplet operations electrode, with or without a droplet thereon. For examples of suitable capacitance detection techniques, see Sturmer et al., International Patent Publication No. WO/2008/101194, entitled “Capacitance Detection in a Droplet Actuator,” published on Aug. 21, 2008; and Kale et al., International Patent Publication No. WO/2002/080822, entitled “System and Method for Dispensing Liquids,” published on Oct. 17, 2002; the entire disclosures of which are incorporated herein by reference.

Droplet actuator 805 may include disruption device 845. Disruption device 845 may include any device that promotes disruption (lysis) of materials, such as tissues, cells and spores in a droplet actuator. Disruption device 845 may, for example, be a sonication mechanism, a heating mechanism, a mechanical shearing mechanism, a bead beating mechanism, physical features incorporated into the droplet actuator 805, an electric field generating mechanism, a thermal cycling mechanism, and any combinations thereof. Disruption device 845 may be controlled by controller 830.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

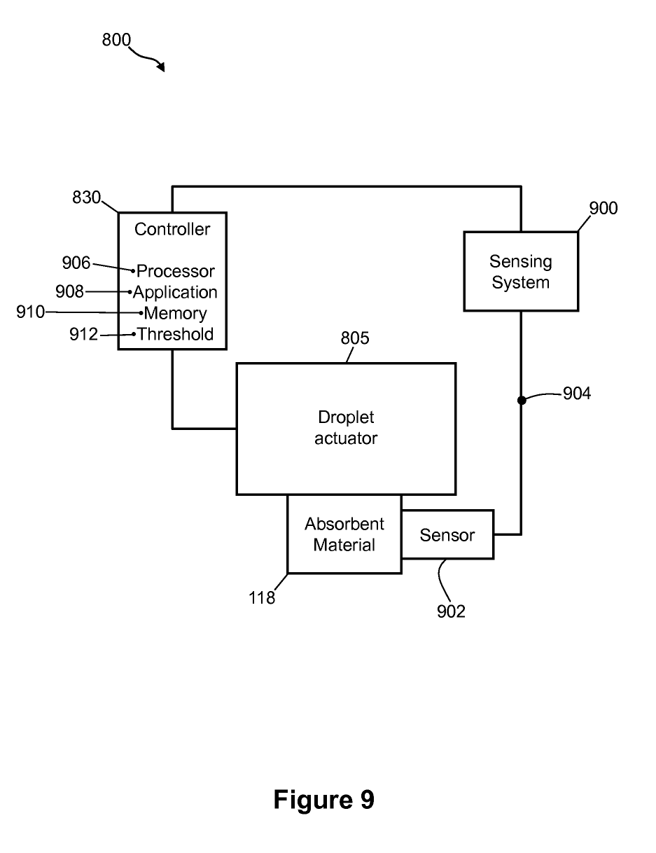

FIG. 9 is another functional block diagram that illustrates the microfluidics system 800. Here again the controller 830 controls the overall operation of microfluidics system 800, such as the droplet actuator 805. In this embodiment, the controller 830 may sense a condition or amount of the absorbent material 118. As droplets are absorbed, an effectiveness of the absorbent material 118 may be reduced, even to a point of saturation. That is, an absorbency of the absorbent material 118 may reduce with time and/or usage, such that fewer droplets may be absorbed over time. At some point the absorbent material 118 may become nearly saturated at which few or no more droplets may be absorbed.

A variety of sensors may be employed. For example, the absorbent material may include a substance which changes color in the presence of water, and the sensor may be a colorimetric sensor. The absorbent material may expand upon contact with water, and the sensor may be a pressure sensor. The absorbent material may expand upon contact with water, and the absorbent material may be included in a chamber which includes a region into which the absorbent material is forced as it becomes saturated. The presence of the absorbent material in the region indicating saturation may be detected using a sensor, such as an optical sensor.

FIG. 9 thus illustrates a sensing system 900. The sensing system 900 periodically or continuously monitors a condition or level of the absorbent material 118. An absorbent sensor 902, for example, may measure an amount of the absorbent material 118 stored or contained within the waste disposal reservoir (such as the off-actuator reservoir 418 illustrated in FIG. 4). The absorbent sensor 902 may additionally or alternatively measure a level of saturation of the absorbent material 118 (such as a level of absorbed liquid, as by electrical conduction or resistance). Regardless, absorbent sensor 902 sends an electrical signal 904 to the controller 830, and the electrical signal 904 represents the condition or level of the absorbent material 118. A processor 906, for example, in the controller 830 receives and analyzes the electrical signal 904. The processor 906 executes a sensor application 908 stored in memory 910, and the sensor application 908 instructs the processor 906 to compare the electrical signal 904 to one or more thresholds 912. If the processor 906 determines that any threshold 912 is satisfied, the processor 906 may flag a condition. The processor 906, for example, may cause a user interface to display a warning message or maintenance alert. A message, for example, may be displayed when the amount of the absorbent material 118 equals or falls below a minimum value that is required for accurate absorption of droplets.

### CONCLUDING REMARKS

The foregoing detailed description of embodiments refers to the accompanying drawings, which illustrate specific embodiments of the invention. Other embodiments having different structures and operations do not depart from the scope of the invention. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the invention may be changed without departing from the scope of the invention. Furthermore, the foregoing description is for the purpose of illustration only, and not for the purpose of limitation.

1. A method, comprising transporting a droplet along a gap to an electrode in a droplet actuator into contact with an absorbent material, thereby disposing of the droplet.

2. The method of claim 1, wherein the absorbent material is separated from the droplet by an oil layer, and the droplet is transported through the oil layer into contact with the absorbent material and absorbed by the absorbent material.

3. The method of claim 1, wherein the absorbent material is separated from the droplet by an oil layer, which oil layer is layered on the absorbent material, and the droplet is transported through the oil layer into contact with the absorbent material and absorbed by the absorbent material.

4. The method of claim 2 wherein the transporting is electrowetting mediated.

5. The method of claim 1, comprising capillaring the droplet from the gap into contact with the absorbent material to cause absorption.

6. The method of claim 1, comprising porting the droplet from the gap into contact with the absorbent material to cause absorption.

7. The method of claim 1, comprising transporting the droplet into contact with the absorbent material to cause absorption.

8. The method of claim 1, comprising flowing the droplet into contact with the absorbent material to cause absorption.

9. The method of claim 1, wherein the absorbent material is provided in an on-actuator reservoir.

10. The method of claim 1, wherein the absorbent material is provided in an off-actuator reservoir.

11. The method of claim 1, wherein the absorbent material is provided in a hybrid reservoir.

12. The method of claim 1, wherein the absorbent material is provided in an off-cartridge reservoir.

13. A system, comprising:
a processor;
memory; and
code stored in the memory that when executed causes the processor at least to:
transport a droplet along a gap between a top surface and a bottom surface of an electrowetting droplet actuator;
activate an electrode in the electrowetting droplet actuator that positions the droplet proximate an absorbent material; and
absorb the droplet by the absorbent material to dispose of the droplet from the gap.

14. The system of claim 13, wherein the code further causes the processor to cause contact between the droplet and the absorbent material.

15. The system of claim 13, wherein the code further causes the processor to cause capillary action of the droplet to the absorbent material.

16. The system of claim 13, wherein the code further causes the processor to flow the droplet from a top substrate of the droplet actuator to the absorbent material.

17. The system of claim 13, wherein the code further causes the processor to flow the droplet from a bottom substrate of the droplet actuator to the absorbent material.

18. The system of claim 13, wherein the code further causes the processor to transport the droplet into contact with the absorbent material.

19. The system of claim 13, wherein the code further causes the processor to flow the droplet into contact with the absorbent material.

20. The system of claim 13, wherein the code further causes the processor to flow the droplet to a reservoir storing the absorbent material.

21. A computer readable medium storing processor executable instructions for performing a method, the method comprising:
transporting a droplet along a gap between a top surface and a bottom surface of an electrowetting droplet actuator;
activating an electrode in the electrowetting droplet actuator that positions the droplet proximate an absorbent material; and
absorbing the droplet by the absorbent material to dispose of the droplet from the gap.

22. The computer readable medium of claim 21, further comprising instructions for contacting the droplet with the absorbent material to cause absorption.

23. The computer readable medium of claim 21, further comprising instructions for capillaring the droplet from the gap to the absorbent material to cause absorption.

24. The computer readable medium of claim 21, further comprising instructions for flowing the droplet into contact with the absorbent material to cause absorption.

25. The computer readable medium of claim 21, further comprising instructions for transporting the droplet into contact with the absorbent material to cause absorption.
